(19) United States
(12) Patent Application Publication
(10) Pub. No.: US 2014/0247189 A1
(43) Pub. Date: Sep. 4, 2014

(54) MULTIBAND WHIP ANTENNA

(71) Applicants: Gennady Babitzki, Haifa (IL); Matti Martiskainen, Tiberias (IL)

(72) Inventors: Gennady Babitzki, Haifa (IL); Matti Martiskainen, Tiberias (IL)

(73) Assignee: GALTRONICS CORPORATION LTD., Tiberias (IL)

(21) Appl. No.: 14/239,670

(22) PCT Filed: Aug. 29, 2012
(86) PCT No.: PCT/IL12/00323

§ 371 Date: May 1, 2014

Related U.S. Application Data
(60) Provisional application No. 61/529,351, filed on Aug. 31, 2011.

(51) Int. Cl. H01Q 5/00

(52) U.S. Cl. CPC H01Q 5/0051
USPC 343/749

(57) ABSTRACT

A multiband antenna, including an elongate radiating element including a first elongate portion and a second elongate portion, a coil galvanically connected to the first elongate portion of the elongate radiating element, a radio-frequency connector galvanically connected to the coil, a conductive layer enclosing at least the coil and the first elongate portion of the elongate radiating element and spaced apart therefrom and at least one conductive choke surrounding a part of the second elongate portion of the elongate radiating element and spaced apart therefrom, the elongate radiating element in conjunction with the at least one conductive choke being operative to radiate in a low frequency band and at least one high frequency band.

### REFERENCE TO RELATED APPLICATIONS

Reference is hereby made to U.S. Provisional Patent Application 61/529,351, entitled GPS WHIP ANTENNA, filed Aug. 31, 2011, the disclosure of which is hereby incorporated by reference and priority of which is hereby claimed pursuant to 37 CFR 1.78(a)(4) and (5)(i).

### FIELD OF THE INVENTION

The present invention relates generally to antennas and more particularly to antennas capable of operating in multiple bands.

### BACKGROUND OF THE INVENTION

The following patent documents are believed to represent the current state of the art:

U.S. patents: U.S. Pat. No. 7,259,728; U.S. Pat. No. 7,202,829 and U.S. Pat. No. 6,229,495.

### SUMMARY OF THE INVENTION

The present invention seeks to provide a multiband whip antenna with improved radiation patterns.

There is thus provided in accordance with a preferred embodiment of the present invention a multiband antenna, including an elongate radiating element including a first elongate portion and a second elongate portion, a coil galvanically connected to the first elongate portion of the elongate radiating element, a radio-frequency connector galvanically connected to the coil, a conductive layer enclosing at least the coil and the first elongate portion of the elongate radiating element and spaced apart therefrom and at least one conductive choke surrounding a part of the second elongate portion of the elongate radiating element and spaced apart therefrom, the elongate radiating element in conjunction with the at least one conductive choke being operative to radiate in a low frequency band and at least one high frequency band, wherein a wavelength of operation λₙ of the elongate radiating element in conjunction with the conductive choke in each one of the low frequency band and the at least one high frequency band is generally given by: λₙ=(2 L)/n, wherein L is an electrical length of the elongate radiating element in conjunction with the at least one conductive choke and n is an integer greater than or equal to 1.

In accordance with a preferred embodiment of the present invention the elongate radiating element and the at least one conductive choke form a composite resonant structure, the composite resonant structure being operative to radiate in at least two frequency bands and the antenna also includes at least one matching structure operative to match an impedance of the composite resonant structure to an impedance of the radio-frequency connector, the at least one matching structure including at least the coil, the radio-frequency connector and the conductive layer.

There is also provided in accordance with a preferred embodiment of the present invention a multiband antenna, including a composite resonant structure including an elongate radiating element and at least one conductive choke surrounding a portion of the elongate radiating element, the composite resonant structure being operative to radiate in at least two frequency bands, a coil galvanically connected to the elongate radiating element, a radio-frequency connector galvanically connected to the coil, a conductive layer enclosing at least the coil and spaced apart therefrom and at least one matching structure operative to match an impedance of the composite resonant structure to an impedance of the radio-frequency connector, the at least one matching structure including at least the coil, the radio-frequency connector and the conductive layer.

Preferably, the at least one conductive choke includes a single conductive choke. Alternatively, the at least one conductive choke includes first and second conductive chokes.

In accordance with a preferred embodiment of the present invention the multiband antenna also includes at least one dielectric spacer separating the elongate radiating element and the at least one conductive choke. Preferably, the at least one matching structure also includes the at least one conductive choke and the at least one dielectric spacer.

In accordance with a preferred embodiment of the present invention the at least one conductive choke is offset from the conductive layer by a gap.

Preferably, the radiating element in conjunction with the at least one conductive choke forms at least one of a half-wavelength resonant structure, a full-wavelength resonant structure and a one and a half times full wavelength resonant structure.

In accordance with a preferred embodiment of the present invention the low frequency band is a 800-900 MHz band and the at least one high frequency band includes at least one of a 1.6 GHz band and a 2.4 GHz band.

Preferably, the antenna is operative to provide a radiation pattern that is primarily directed upwards in a 1.6 GHz band.

### BRIEF DESCRIPTION OF THE DRAWINGS

The present invention will be understood and appreciated more fully from the following detailed description, taken in conjunction with the drawings in which:

FIGS. 1A and 1B are simplified respective perspective and cross-sectional view illustrations of an antenna constructed and operative in accordance with a preferred embodiment of the present invention;

FIGS. 2A and 2B are simplified respective perspective and cross-sectional view illustrations of an antenna constructed and operative in accordance with another preferred embodiment of the present invention;

FIGS. 3A and 3B are simplified respective perspective and cross-sectional view illustrations of an antenna constructed and operative in accordance with yet another preferred embodiment of the present invention; and

FIG. 4 is a simplified graph showing a radiation pattern of an antenna of the types illustrated in FIGS. 1B and 3B.

### DETAILED DESCRIPTION OF PREFERRED EMBODIMENTS

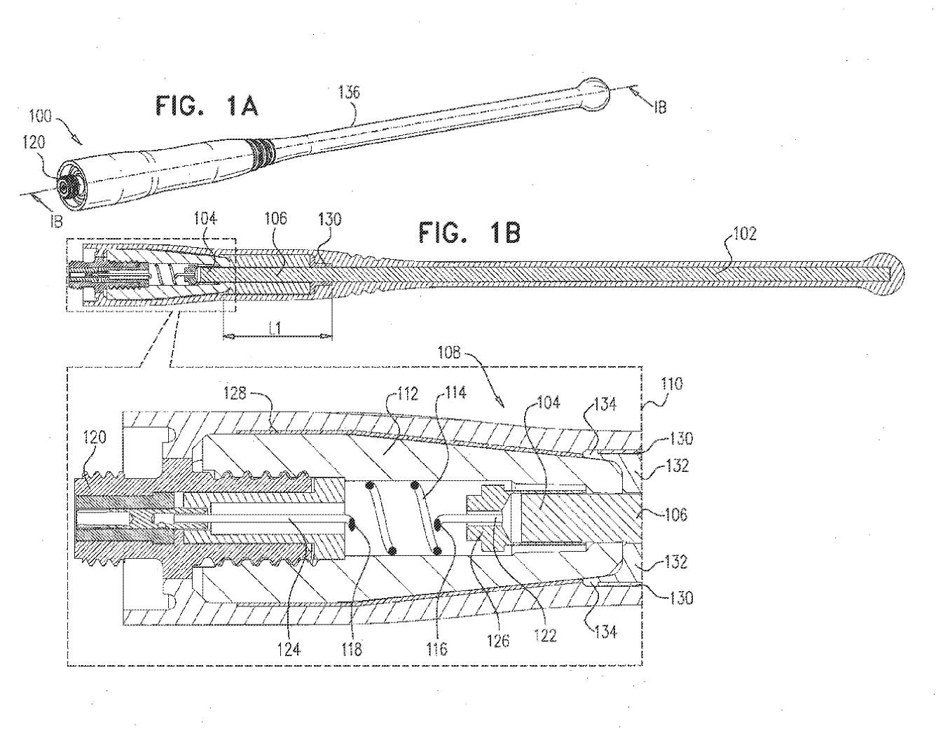

Reference is now made to FIGS. 1A and 1B, which are simplified respective perspective and cross-sectional view illustrations of an antenna constructed and operative in accordance with a preferred embodiment of the present invention.

As seen in FIGS. 1A and 1B, there is provided an antenna 100 including an elongate radiating element 102. It is appreciated by one skilled in the art that due to the elongate nature of radiating element 102, antenna 100 generally resembles a whip type antenna. However, antenna 100 is preferably capable of multiband performance and exhibits improved radiation patterns in comparison to conventional whip antennas due to its unique radiating and matching structures, as will be described henceforth.

Elongate radiating element 102 preferably includes a first elongate portion 104 and a second elongate portion 106, which first elongate portion 104 is preferably fixedly coupled to a holder 108. As seen most clearly at enlargement 110, holder 108 preferably includes an insulative housing 112 and a coil 114, which coil 114 is galvanically connected at a first terminus 116 to the first portion 104 of radiating element 102.

Coil 114 is preferably galvanically connected at a second terminus 118 to a radio-frequency (RF) connector 120, which RF connector 120 is operative to deliver an RF signal to radiating element 102. Coil 114 is shown to be respectively galvanically connected to the first portion 104 of radiating element 102 and to the RF connector 120 by way of first and second conductive arms 122 and 124. It is appreciated, however, that the particular configuration of conductive arms 122 and 124 shown in FIG. 1B is exemplary only and that conductive arms 122 and 124 may be embodied in a variety of suitable configurations. Coil 114 may alternatively be directly galvanically connected to one or both of first portion 104 and RF connector 120, whereby one or both of conductive arms 122 and 124 may be obviated. In the embodiment of antenna 100 illustrated in FIG. 1B, first conductive arm 122 is shown to be enclosed by a bushing section 126. Alternatively, bushing section 126 may be obviated or replaced by a different conductive structure.

A conductive layer 128 is provided enclosing at least the coil 114 and the first portion 104 of radiating element 102 and spaced apart therefrom. Here, by way of example, conductive layer 128 is preferably embodied as a conductive tape wound around the surface of housing 112, thereby enclosing coil 114, first portion 104, a section of RF connector 120 and conductive arms 122 and 124. Conductive layer 128 is preferably spaced apart from coil 114 and first portion 104 of radiating element 102 by a width of housing 112. Coil 114, in combination with conductive layer 128, contributes to form a matching structure, which matching structure matches the naturally high impedance of radiating element 102 to the lower input impedance of RF connector 120, as will be detailed henceforth.

It is a particular feature of a preferred embodiment of the present invention that at least one tube-like conductive choke, here embodied as a single conductive choke 130, is provided surrounding a part of the second portion 106 of radiating element 102 and spaced apart therefrom. In the embodiment of the invention illustrated in FIG. 1B, choke 130 surrounds a lower part of second portion 106 and is spaced apart therefrom by way of a dielectric spacer 132. Dielectric spacer 132 may comprise any suitable material having a dielectric constant ≧3.0, such as polycarbonate or polyacetal.

Choke 130 serves to build up impedance along the second portion 106 of radiating element 102. The creation of such localized impedance allows radiating element 102, in conjunction with choke 130, to operate as a multiband radiating element, preferably capable of radiating in a low frequency band and at least one high frequency band. In the absence of choke 130, elongate radiating element 102 would function as a single-band radiating element, incapable of effectively supporting additional high frequency bands.

A wavelength of operation, λₙ, of radiating element 102 in conjunction with choke 130 in each one of the low frequency and high frequency bands of operation of antenna 100 is generally given by:

λₙ=(2 L)/n (1)

wherein L is an electrical length of radiating element 102 in conjunction with choke 130 and n is an integer greater than or equal to 1, a value of n in the low frequency band being less than a value of Pi in the at least one high frequency band.

By way of example, in the embodiment of the invention illustrated in FIG. 1B, antenna 100 is preferably operative as a dual band antenna, capable of operating in a low frequency 800-900 MHz band and a high frequency 1.6 GHz band.

In the low frequency 800-900 MHz band, radiating element 102 in conjunction with choke 130 forms a half-wavelength resonant structure. In terms of equation (1), n=1 for the 800-900 MHz band of operation.

In the high frequency 1.6 GHz band, radiating element 102 in conjunction with choke 130 forms a full-wavelength resonant structure. In terms of equation (1), n=2 for the 1.6 GHz band of operation. Radiating element 102 is typically approximately 140 mm in length and a typical length of choke 130, designated in FIG. 1B as L1, is typically approximately 25 mm.

It is understood that these specific frequency values for the low and high frequency bands of operation of antenna 100 are exemplary only. As is appreciated from consideration of equation (1), antenna 100 may be adapted to operate in multiple high frequency bands over a variety of frequency ranges, provided that the respective wavelengths of operation in the low and high frequency bands conform to the relationship described by equation (1).

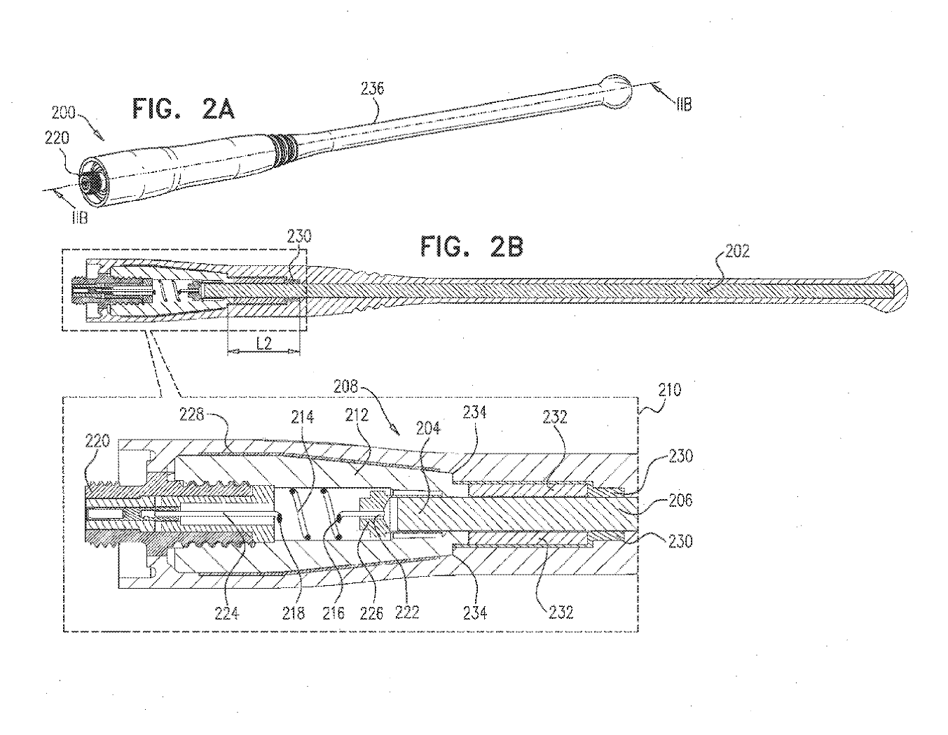

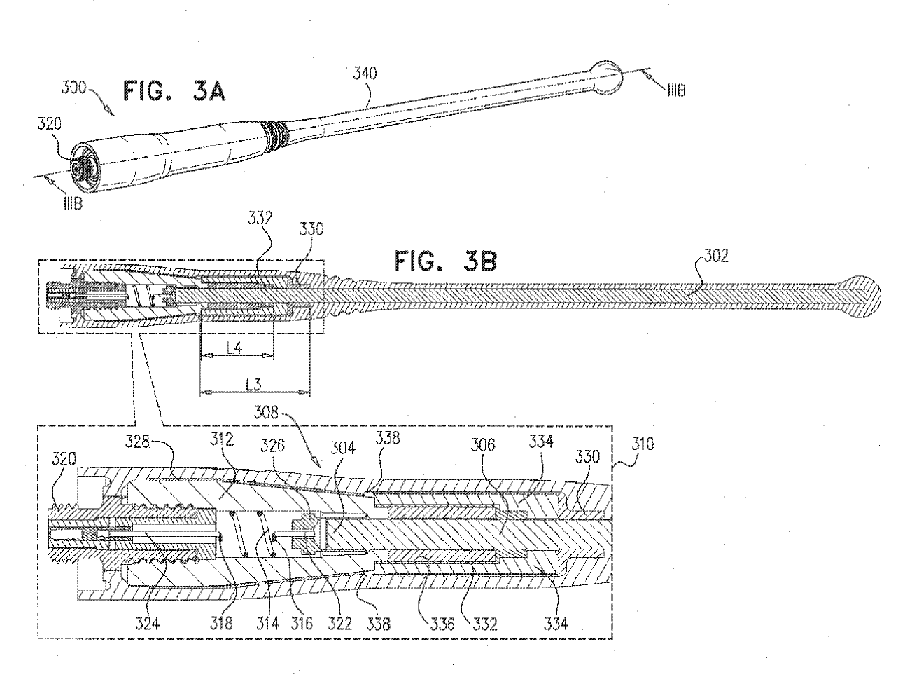

It is further appreciated from consideration of equation (1) that the wavelengths of operation of antenna 100 may be modified by way of adjustment of the electrical length of the choke 130 without altering the electrical length of the elongate radiating element 102, as will be detailed henceforth in reference to FIGS. 2A-3B.

It is a further particular feature of a preferred embodiment of the present invention that the composite resonant element of antenna 100, namely radiating element 102 in conjunction with choke 130, is matched to the input impedance of RF connector 120 for each operating frequency of antenna 100 by way of a unique matching structure.

In the low frequency 800-900 MHz band, radiating element 102 in conjunction with choke 130 is matched to the input impedance by way of a first matching structure, which first matching structure preferably comprises the RF connector 120, coil 114, conductive layer 128 and bushing 126.

In the high frequency 1.6 GHz band, radiating element 102 in conjunction with choke 130 is matched to the input impedance by way of a second matching structure, which second matching structure preferably comprises the first matching structure, namely the RF connector 120, coil 114, conductive layer 128 and bushing 126, in addition to choke 130 and dielectric spacer 132. It is appreciated that in the high frequency 1.6 GHz band of operation of antenna 100, choke 130 thus has a dual function, both as a portion of the composite resonant structure and as a portion of the matching structure therefor.

It is understood that although bushing 126 is listed above as comprising a portion of both the first and second matching structures, bushing 126 is not an essential feature of antenna 100, as has been described above. Bushing 126 may hence be optionally obviated from the first and/or second matching structures or replaced by a different equivalent conductive element, in accordance with the design requirements of antenna 100.

As seen most clearly at enlargement 110, choke 130 is offset from conductive layer 128 by a gap 134. The size of gap 134 is a critical parameter in controlling the efficacy of the above-described first and second matching structures. Gap 134 is preferably of the order of 1 mm for the antenna illustrated in FIG. 1B.

It is thus appreciated that due to the presence and relative arrangement of radiating element 102, coil 114, RF connector 120, conductive layer 128, choke 130 and dielectric spacer 132, antenna 100 may operate as a dual resonance antenna, radiating in both the 800-900 MHz and 1.6 GHz frequency bands. Antenna 100 is furthermore well matched to a radio device in both resonant ranges.

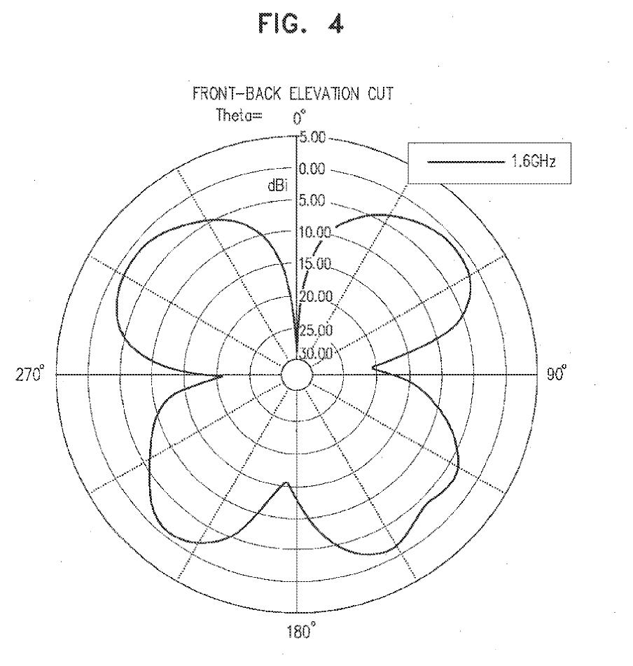

It will further be apparent to one skilled in the art that the high frequency 1.6 GHz band of operation of antenna 100 corresponds to the frequency band used in Global Positioning Systems (GPS). Antenna 100 is particularly well suited for use in GPS applications due to its radiation pattern in the 1.6 GHz band. In contrast to conventional whip antennas, which conventional whip antennas typically radiate predominantly in the azimuth, antenna 100 has a radiation pattern that is primarily directed upwards at 1.6 GHz, as seen in FIG. 4. The altered GPS radiation pattern of antenna 100 in comparison to that of conventional whip antennas is due to the fact that in operation at 1.6 GHz the entire length of antenna 100, including elongate element 102 and choke 130, effectively functions as a radiating element, rather than radiating element 102 or choke 130 alone acting as the radiating element. This leads to a changed radiation pattern in comparison to that of conventional whip antennas, resulting in antenna 100 being particularly suited to GPS applications, in which at least a portion of radiation is preferably directed upwards.

As seen in FIG. 1A, antenna 100 may be enclosed by an outer sheath 136 so as to enhance its durability and mechanical stability. Elongate radiating element 102 may be formed of any suitable conductive material and is preferably embodied as a flexible shaft cable. Coil 114 is illustrated in FIG. 1B as comprising two turns of equal radius, although it is appreciated that the number and radii of the turns of coil 114 may be varied according to the operational requirements of antenna 100.

Reference is now made to FIGS. 2A and 2B, which are simplified respective perspective and cross-sectional view illustrations of an antenna constructed and operative in accordance with another preferred embodiment of the present invention.

As seen in FIGS. 2A and 2B, there is provided a whip-type antenna 200. Antenna 200 includes an elongate radiating element 202, which elongate radiating element 202 preferably includes a first elongate portion 204 and a second elongate portion 206, which first elongate portion 204 is preferably fixedly coupled to a holder 208. As seen most clearly at enlargement 210, holder 208 preferably includes an insulative housing 212 and a coil 214, which coil 214 is galvanically connected at a first terminus 216 to the first portion 204 of radiating element 202.

Coil 214 is preferably galvanically connected at a second terminus 218 to a RF connector 220, which RF connector 220 is operative to deliver an RF signal to radiating element 202. Coil 214 is shown to be respectively galvanically connected to the first portion 204 of radiating element 202 and to the RF connector 220 by way of first and second conductive arms 222 and 224. It is appreciated, however, that the particular configuration of conductive arms 222 and 224 shown in FIG. 2B is exemplary only and that conductive arms 222 and 224 may be embodied in a variety of suitable configurations. Coil 214 may alternatively be directly galvanically connected to one or both of first portion 204 and RF connector 220, whereby one or both of conductive arms 222 and 224 may be obviated. In the embodiment of antenna 200 illustrated in FIG. 2B, first conductive arm 222 is shown to be enclosed by a bushing section 226. Alternatively, bushing 226 may be obviated or replaced by a different conductive structure.

A conductive layer 228 is provided enclosing at least the coil 214 and the first portion 204 of radiating element 202 and spaced apart therefrom. Here, by way of example, conductive layer 228 is preferably embodied as a conductive tape wound around the surface of housing 212, thereby enclosing coil 214, first portion 204, a section of RF connector 220, and conductive arms 222 and 224. Conductive layer 228 is spaced apart from coil 214 and first portion 204 of radiating element 202 by a width of housing 212. Coil 214, in combination with conductive layer 228, contributes to form a matching structure, which matching structure matches the naturally high impedance of radiating element 202 to the lower input impedance of RF connector 220, as will be detailed henceforth.

It is a particular feature of a preferred embodiment of the present invention that at least one tube-like conductive choke, here embodied as a single conductive choke 230, is provided surrounding a part of the second portion 206 of radiating element 202 and spaced apart therefrom. In the embodiment of the invention illustrated in FIG. 2B, choke 230 surrounds a lower part of radiating element 202 and is spaced apart from radiating element 202 by way of a dielectric spacer 232. Dielectric spacer 232 may comprise any suitable material having a dielectric constant ≧3.0, such as polycarbonate or polyacetal.

Choke 230 serves to build up impedance along the second portion 206 of radiating element 202. The creation of such localized impedance allows radiating element 202, in conjunction with choke 230, to operate as a multiband radiating element preferably capable of radiating in a low frequency band and at least one high frequency band. In the absence of choke 230, elongate radiating element 202 would function as a single-band radiating element, incapable of effectively supporting additional high frequency bands.

A wavelength of operation λₙ of radiating element 202 in conjunction with choke 230 in each one of the low frequency and high frequency bands of operation of antenna 200 is generally given by:

λₙ=(2 L)/n (2)

wherein L is an electrical length of the radiating element 202 in conjunction with choke 230 and n is an integer greater than or equal to 1, a value of n in the low frequency band being less than a value of n in the at least one high frequency band.

By way of example, in the embodiment of the invention illustrated in FIG. 2B, antenna 200 is preferably operative as a dual band antenna, preferably capable of operating in a low frequency 800-900 MHz band and a high frequency 2.4 GHz band.

In the low frequency 800-900 MHz band, radiating element 202 in conjunction with choke 230 forms a half-wavelength resonant structure. In terms of equation (2), n=1 for the 800-900 MHz band of operation. In the high frequency 2.4 GHz band, radiating element 202 in conjunction with choke 230 forms a one and a half times full-wavelength resonant structure. In terms of equation (2), n=3 for the 2.4 GHz band of operation.

It is appreciated from the above-described structure and operation of antenna 200, that antenna 200 may generally resemble antenna 100 in every relevant respect with the exception of in its high frequency band of operation. Whereas the high frequency band of operation of antenna 200 lies in the 2.4 GHz range, the high frequency band of operation of antenna 100 lies in the 1.6 GHz range. This difference in the high frequency band of operation of antenna 100 compared to that of antenna 200 arises due to the difference in the size of choke 130 in comparison to the size of choke 230, as is apparent from comparison of FIG. 1B to FIG. 2B.

Radiating element 202 is typically approximately 140 mm in length and a typical length of choke 230, designated in FIG. 2B as L2, is typically approximately 15 mm The typical lengths of chokes 130 and 230 described herein are suitable for the high frequency bands described herein for antennas 100 and 200.

It is appreciated that the particular dimensions of radiating element 102 and choke 130 and radiating element 202 and choke 230, respectively illustrated in FIGS. 1B and 2B, and hence the corresponding frequency bands of operation of antennas 100 and 200, are exemplary only. Antennas 100 and 200 may be readily modified by one skilled in the art so as to include elongate radiating elements and/or chokes of various lengths, whereby the low and high frequency bands of operation of the antennas may be adjusted.

It is a further particular feature of a preferred embodiment of the present invention that the composite resonant element of antenna 200, namely radiating element 202 in conjunction the choke 230, is matched to the input impedance of RF connector 220 at each operating frequency of antenna 200 by way of a unique matching structure.

In the low frequency 800-900 MHz band, radiating element 202 in conjunction with choke 230 is preferably matched to the input impedance by way of a first matching structure, which first matching structure preferably comprises the RF connector 220, coil 214, conductive layer 228 and bushing 226.

In the high frequency 2.4 GHz band, radiating element 202 in conjunction with choke 230 is preferably matched to the input impedance by way of a second matching structure, which second matching structure preferably comprises the first matching structure, namely the RF connector 220, coil 214, conductive layer 228 and bushing 226, in addition to choke 230 and dielectric spacer 232. It is appreciated that in the high frequency 2.4 GHz band of operation of antenna 200, choke 230 thus has a dual function, both as a portion of the composite resonant structure and as a portion of the matching structure therefor.

It is understood that although bushing 226 is listed above as comprising a portion of both the first and second matching structures, bushing 226 is not an essential feature of antenna 200, as has been described above. Bushing 226 may hence be optionally obviated from the first and/or second matching structures or replaced by a different equivalent conductive element, in accordance with the design requirements of antenna 200.

As seen most clearly at enlargement 210, choke 230 is offset from conductive layer 228 by a gap 234. The size of gap 234 is a critical parameter in controlling the efficacy of the above-described first and second matching structures. Gap 234 is preferably of the order of 1 mm for the antenna illustrated in FIG. 2B.

It is thus appreciated that, due to the presence and relative arrangement of radiating element 202, coil 214, RF connector 220, conductive layer 226, choke 230 and dielectric spacer 232, antenna 200 may operate as a dual resonance antenna, radiating in both the 800-900 MHz and 2.4 GHz frequency bands. Antenna 200 is furthermore well matched to a radio device in both resonant ranges.

As seen in FIG. 2A, antenna 200 may be enclosed by an outer sheath 236 so as to enhance its durability and mechanical stability. Elongate radiating element 202 may be formed of any suitable conductive material and is preferably embodied as a flexible shaft cable. Coil 214 is illustrated in FIG. 2B as comprising two turns of equal radius, although it is appreciated that the number and radii of the turns of coil 214 may be varied according to the operational requirements of antenna 200.

Reference is now made to FIGS. 3A and 3B, which are simplified respective perspective and cross-sectional view illustrations of an antenna constructed and operative in accordance with yet another preferred embodiment of the present invention,

As seen in FIGS. 3A and 3B, there is provided a whip-type antenna 300. Antenna 300 includes an elongate radiating element 302, which elongate radiating element 302 preferably includes a first elongate portion 304 and a second elongate portion 306, which first elongate portion 304 is preferably fixedly coupled to a holder 308. As seen most clearly at enlargement 310, holder 308 preferably includes an insulative housing 312 and a coil 314, which coil 314 is galvanically connected at a first terminus 316 to the first portion 304 of radiating element 302.

Coil 314 is preferably galvanically connected at a second terminus 318 to a radio-frequency (RF) connector 320, which RF connector 320 is operative to deliver an RF signal to radiating element 302. Coil 314 is shown to be respectively galvanically connected to the first portion 304 of radiating element 302 and to the RF connector 320 by way of first and second conductive arms 322 and 324. It is appreciated, however, that the particular configuration of conductive arms 322 and 324 shown in FIG. 3B is exemplary only and that conductive arms 322 and 324 may be embodied in a variety of suitable configurations. Coil 314 may alternatively be directly galvanically connected to one or both of first portion 304 and RF connector 320, whereby one or both of conductive arms 322 and 324 may be obviated. In the embodiment of antenna 300 illustrated in FIG. 3B, first conductive arm 322 is shown to be enclosed by a bushing section 326. Alternatively, bushing 326 may be obviated or replaced by a different conductive structure.

A conductive layer 328 is provided enclosing at least the coil 314 and the first portion 304 of radiating element 302 and spaced apart therefrom. Here, by way of example, conductive layer 328 is preferably embodied as a conductive tape wound around the surface of housing 312, thereby enclosing coil 314, first portion 304, a section of RF connector 320, and conductive arms 322 and 324. Conductive layer 328 is spaced apart from coil 314 and first portion 304 of radiating element 302 by a width of housing 312. Coil 314, in combination with conductive layer 328, contributes to form a matching structure, which matching structure matches the naturally high impedance of radiating element 302 to the lower input impedance of RF connector 320, as will be detailed henceforth.

It is a particular feature of a preferred embodiment of the present invention that at least one tube-like conductive choke, here embodied as a first conductive choke 330 and a second conductive choke 332, is provided surrounding a part of the second portion 306 of radiating element 302 and spaced apart therefrom. In the embodiment of the invention illustrated in FIG. 3B, first and second chokes 330 and 332 are respectively spaced apart from elongate radiating element 306 by way of first and second dielectric spacers 334 and 336. Dielectric spacers 334 and 336 may comprise any suitable material having a dielectric constant ≧3.0, such as polycarbonate, or polyacetal.

First and second chokes 330 and 332 serve to build up impedance along the second portion 306 of radiating element 302. The creation of such localized impedance allows radiating element 302, in conjunction with chokes 330 and 332, to operate as a tri-band radiating element preferably capable of radiating in a low frequency band and two high frequency bands. In the absence of chokes 330 and 332, elongate radiating element 302 would function as a single-band radiating element, incapable of effectively supporting additional high frequency bands.

A wavelength of operation λₙ of radiating element 302 in conjunction with each one of chokes 330 and 332, in each one of the low frequency and high frequency bands of operation of antenna 300 is generally given by:

λₙ=(2 L)/n (3)

wherein L is an electrical length of the radiating element 302 in conjunction with respective ones of choke 330 and 332 and n is an integer greater than or equal to 1, a value of n in the low frequency band being less than a value of n in the at least one high frequency band.

By way of example, in the embodiment of the invention illustrated in FIG. 3B, antenna 330 is preferably operative as a tri-band antenna, capable of operating in a low frequency 800-900 MHz band and two high frequency bands of approximately 1.6 and 2.4 GHz.

In the low frequency 800-900 MHz band, radiating element 302 in conjunction with choke 330 forms a half-wavelength resonant structure. In terms of equation (3), n=1 for the 800-900 MHz band of operation. It is appreciated that in the antenna shown in FIG. 3B, choke 332 does not function as part of the resonant structure in the low frequency band.

In the high frequency 1.6 GHz band, radiating element 302 in conjunction with choke 330 forms a full-wavelength resonant structure. In terms of equation (3), n=2 for the 1.6 GHz band of operation. It is appreciated that in the antenna shown in FIG. 3B, choke 332 does not function as part of the resonant structure in the high frequency 1.6 GHz band.

In the high frequency 2.4 GHz band, radiating element 302 in conjunction with choke 332 forms a one and a half times full-wavelength resonant structure. In terms of equation (3), n=3 for the 2.4 GHz band of operation. It is appreciated that in the antenna shown in FIG. 3B, choke 330 does not function as part of the resonant structure in the high frequency 2.4 GHz band.

Radiating element 302 is typically approximately 140 mm in length. A typical length of choke 330, designated in FIG. 3B as L3, is typically approximately 25 mm, and a typical length of choke 332, designated in FIG. 3B as L4, is typically approximately 15 mm The typical lengths of chokes 330 and 332 described herein are suitable for the high frequency bands described herein for antenna 300.

It is appreciated from the above-described structure and operation of antenna 300, that antenna 300 may generally resemble antenna 100 in every relevant respect with the exception of in its high frequency bands of operation. Whereas antenna 100 operates in only a single high frequency band lying in the 1.6 GHz range, antenna 300 operates in two high frequency bands lying in the 1.6 and 2.4 GHz ranges. This difference in the high frequency band of operation of antenna 100 compared to those of antenna 300 arises due to the provision of an additional choke, namely choke 332, in antenna 300, as is apparent from comparison of FIG. 1B to FIG. 3B.

It is further understood that choke 330 may generally resemble choke 130 of antenna 100 and that choke 332 may generally resemble choke 230 of antenna 200. Antenna 300 thus may be considered to be an amalgamation of antennas 100 and 200, including both of chokes 130 and 230 of respective antennas 100 and 200 and hence providing both of the high frequency bands of operation thereof.

It is a particular feature of a preferred embodiment of the present invention that the composite resonant elements of antenna 300, namely the radiating element 302 in conjunction the choke 330 and the radiating element 302 in conjunction with the choke 332, are each matched to the input impedance of RF connector 320 at each of antenna 300's operating frequencies by way of a unique matching structure.

In the low frequency 800-900 MHz band, radiating element 302 in conjunction with choke 330 is matched to the input impedance by way of a first matching structure, which first matching structure preferably comprises the RF connector 320, coil 314, conductive layer 328 and bushing 326.

In the high frequency 1.6 GHz band, radiating element 302 in conjunction with choke 330 is preferably matched to the input impedance by way of a second matching structure, which second matching structure preferably comprises the first matching structure, namely the RF connector 320, coil 314, conductive layer 328 and bushing 326, in addition to choke 330 and its dielectric spacer 334.

In the high frequency 2.4 GHz band, radiating element 302 in conjunction with choke 332 is preferably matched to the input impedance by way of a third matching structure, which third matching structure preferably comprises the first matching structure, namely the RF connector 320, coil 314, conductive layer 328 and bushing 326, in addition to choke 332 and its dielectric spacer 336.

It is thus appreciated that, in the high frequency 1.6 and 2.4 GHz bands of operation of antenna 300, chokes 330 and 332 thus each have a dual function, both as a portion of the composite resonant structure and as a portion of the matching structure therefor.

It is further appreciated that antenna 300 in its 1.6 GHz band of operation generally shares the features and advantages described above with reference to antenna 100 in its 1.6 GHz band of operation, including in particular the antennas' upwardly directed GPS radiation pattern, illustrated in FIG. 4.

As seen most clearly at enlargement 310, chokes 330 and 332 are offset from conductive layer 328 by a gap 338. The size of gap 338 is a critical parameter in controlling the efficacy of the above-described first and second matching structures. Gap 338 is preferably of the order of 1 mm for the antenna illustrated in FIG. 3B.

It is thus appreciated that, due to the presence and relative arrangement of radiating element 302, coil 314, RF connector 320, conductive layer 328, chokes 330 and 332 and dielectric spacers 334 and 336, antenna 300 may operate as a tri-resonant antenna, radiating in the 800-900 MHz, 1.6 GHz and 2.4 GHz frequency bands. Antenna 300 is furthermore well matched to a radio device in both resonant ranges.

As seen in FIG. 3A, antenna 300 may be enclosed by an outer sheath 340 so as to enhance its durability and mechanical stability. Elongate radiating element 302 may be formed of any suitable conductive material and is preferably embodied as a flexible shaft cable. Coil 314 is illustrated in FIG. 3B as comprising two turns of equal radius, although it is appreciated that the number and radii of the turns of coil 314 may be varied according to the operational requirements of antenna 300.

It is appreciated by one skilled in the art that the sizes of elongate radiating element 302 and chokes 330 and 332 in antenna 300 are exemplary only and that antenna 300 may be readily modified by one skilled in the art to include a greater number of chokes of various sizes, whereby the high frequency bands of operation of the antenna may be adjusted in conformance with the relationship described by equation (3).

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A multiband antenna, comprising:
an elongate radiating element comprising a first elongate portion and a second elongate portion;
a coil galvanically connected to said first elongate portion of said elongate radiating element;
a radio-frequency connector galvanically connected to said coil;
a conductive layer enclosing at least said coil and said first elongate portion of said elongate radiating element and spaced apart therefrom; and
at least one conductive choke surrounding a part of said second elongate portion of said elongate radiating element and spaced apart therefrom, said elongate radiating element in conjunction with said at least one conductive choke being operative to radiate in a low frequency band and at least one high frequency band, wherein a wavelength of operation λₙ of said elongate radiating element in conjunction with said conductive choke in each one of said low frequency band and said at least one high frequency band is generally given by:
λₙ=(2 L)/n
wherein L is an electrical length of said elongate radiating element in conjunction with said at least one conductive choke and n is an integer greater than or equal to 1.

2. A multiband antenna according to claim 1 and wherein said at least one conductive choke comprises a single conductive choke.

3. A multiband antenna according to claim 1 and wherein said at least one conductive choke comprises first and second conductive chokes.

4. A multiband antenna according to claim 1 wherein:
said elongate radiating element and said at least one conductive choke form a composite resonant structure, said composite resonant structure being operative to radiate in at least two frequency bands; and
said antenna also comprises:
at least one matching structure operative to match an impedance of said composite resonant structure to an impedance of said radio-frequency connector, said at least one matching structure comprising at least said coil, said radio-frequency connector and said conductive layer.

5. A multiband antenna according to claim 4 and also comprising at least one dielectric spacer separating said elongate radiating element and said at least one conductive choke.

6. A multiband antenna according to claim 5 wherein said at least one matching structure also comprises said at least one conductive choke and said at least one dielectric spacer.

7. A multiband antenna according to claim 1 wherein said at least one conductive choke is offset from said conductive layer by a gap.

8. A multiband antenna according to claim 1 and wherein said radiating element in conjunction with said at least one conductive choke forms at least one of a half-wavelength resonant structure, a full-wavelength resonant structure and a one and a half times full wavelength resonant structure.

9. A multiband antenna according to claim 1 and wherein said low frequency band is a 800-900 MHz band and said at least one high frequency band includes at least one of a 1.6 GHz band and a 2.4 GHz band.

10. A multiband antenna according to claim 1 wherein said antenna is operative to provide a radiation pattern that is primarily directed upwards in a 1.6 GHz band.

11. A multiband antenna, comprising:
a composite resonant structure comprising:
an elongate radiating element; and
at least one conductive choke surrounding a portion of said elongate radiating element, said composite resonant structure being operative to radiate in at least two frequency bands;
a coil galvanically connected to said elongate radiating element;
a radio-frequency connector galvanically connected to said coil;
a conductive layer enclosing at least said coil and spaced apart therefrom; and
at least one matching structure operative to match an impedance of said composite resonant structure to an impedance of said radio-frequency connector, said at least one matching structure comprising at least said coil, said radio-frequency connector and said conductive layer.

12. A multiband antenna according to claim 11 and wherein said at least one conductive choke comprises a single conductive choke.

13. A multiband antenna according to claim 11 and wherein said at least one conductive choke comprises first and second conductive chokes.

14. A multiband antenna according to claim 11 and also comprising at least one dielectric spacer separating said elongate radiating element and said at least one conductive choke.

15. A multiband antenna according to claim 14 wherein said at least one matching structure also comprises said at least one conductive choke and said at least one dielectric spacer.

16. A multiband antenna according to claim 11 wherein said at least one conductive choke is offset from said conductive layer by a gap.

17. A multiband antenna according to claim 11 and wherein said radiating element in conjunction with said at least one conductive choke forms at least one of a half-wavelength resonant structure, a full-wavelength resonant structure and a one and a half times full wavelength resonant structure.

18. A multiband antenna according to claim 11 and wherein said low frequency band is a 800-900 MHz band and said at least one high frequency band includes at least one of a 1.6 GHz band and a 2.4 GHz band.

19. A multiband antenna according to claim 11 wherein said antenna is operative to provide a radiation pattern that is primarily directed upwards in a 1.6 GHz band.
